(19) United States
(12) Patent Application Publication
(10) Pub. No.: US 2021/0114463 A1
(43) Pub. Date: Apr. 22, 2021

(54) JOINING STRUCTURE OF FRONT PILLAR TRIM AND INSTRUMENT PANEL

(71) Applicant: HONDA MOTOR CO., LTD., Tokyo (JP)

(72) Inventors: Hiroyuki Sukigara, Wako-shi (JP); Yujiro Goto, Wako-shi (JP)

(21) Appl. No.: 17/064,632

(22) Filed: Oct. 7, 2020

(30) Foreign Application Priority Data
Oct. 21, 2019 (JP) 2019-191944

(51) Int. Cl. B60K 37/02

(52) U.S. Cl. CPC B60K 37/02; B60K 2370/688; B60K 2370/654; B60K 2370/152

(57) ABSTRACT

The present provides a joining structure for a front pillar trim and an instrument panel capable of preventing designability from being impaired and stabilizing a height position of a parting line. A joining structure (20) of a front pillar trim and an instrument panel includes a front pillar trim (15) and an instrument panel (12). The front pillar trim includes a lower trim (32) and a front upper trim (31), which are coupled via a first coupling section (41). The lower trim has an extension section (45) extending inward from a first coupling section in a vehicle width direction and abutting the instrument panel. A parting section (62) is formed between the extension section and the instrument panel. The parting section forms an angle that supports a ride feeling of a driver.

### CROSS-REFERENCE TO RELATED APPLICATION

Priority is claimed on Japanese Patent Application No. 2019-191944, filed Oct. 21, 2019, the content of which is incorporated herein by reference.

### BACKGROUND OF THE INVENTION

### Field of the Invention

The present invention relates to a joining structure for a front pillar trim and an instrument panel.

### Description of Related Art

It is known that the information obtained by a driver who is driving a vehicle is not only based on the scenery outside the vehicle that is able to be recognized through a front window or the like but is also affected by a structure in a vehicle interior that come into a field of view together with the scenery outside the vehicle. That is, it is conceivable that the information on the environment external to a vehicle perceived by a driver may differ depending on the structure in the vehicle interior that comes into a field of view in cases in which the same scenery is visible though the front window or the like.

As a countermeasure for this, it is known that, in a state in which a driver visually checks a side in front of the vehicle, an outline of a structure in a vehicle interior disposed inside a field of view of the driver may be configured to substantially coincide with an axis directed toward the inside of the vehicle interior among axes extending radially from a vanishing point in front of the vehicle. Since the outline of the structure in the vehicle interior substantially coincides with the axis directed toward the inside of the vehicle interior, the outline has a function of a parting line that supports a ride feeling of the driver (hereinafter, referred to as a parting section).

As the structure in the vehicle interior, at least one of a window frame, a casing of a center display (outer edges of both sides), and an outer edge of a meter hood may be exemplified (for example, see Patent Document 1 (Japanese Patent No. 6575935)).

### SUMMARY OF THE INVENTION

Here, for example, a coupling section for a lower end portion of a front pillar trim and an outer side portion of an instrument panel is an area disposed in a vehicle interior and conceivable as a structure in a vehicle interior in Patent Document 1. Further, the coupling section is disposed in front of the driver and extends in a forward/rearward direction of a vehicle body. For this reason, it is conceivable that the coupling section be used as the parting section.

However, the front pillar trim is generally formed of a resin material and extends from an upper end portion to a lower end portion with a downward gradient in a forward direction of the vehicle. Accordingly, since the front pillar trim expands and contracts according to variation in environmental temperature, a lower end portion thereof may be displaced to a certain extent in an upward/downward direction. For this reason, it is conceivable that distortion will occur in the coupling section of the lower end portion of the front pillar trim and the outer side portion of the instrument panel and the design will be impaired.

As a countermeasure for this, it is also conceivable to provide a structure configured to cause a height position of the coupling section to follow the upward/downward direction so as not to impair the design. However, when the height position of the coupling section follows the upward/downward direction, the parting section cannot support the ride feeling of the driver due to fluctuation of the parting section.

The present invention is directed to providing a joining structure for a front pillar trim and an instrument panel capable of preventing designability from being impaired and stabilizing a height position of a parting line.

A joining structure for a front pillar trim and an instrument panel of the present invention employ the following configurations.

(1) A joining structure for a front pillar trim and an instrument panel (for example, a joining structure (20) of a front pillar trim (15) and an instrument panel (12) of an embodiment) according to an aspect of the present invention is a joining structure for a front pillar trim and an instrument panel, wherein the front pillar trim includes an upper trim (for example, a front upper trim (31) of the embodiment) and a lower trim (for example, a lower trim (32) of the embodiment), the lower trim and the upper trim being coupled via a coupling section (for example, a first coupling section (41) of the embodiment), the lower trim having an extension section (for example, an extension section (45) of the embodiment) extending from the coupling section toward an inward side in a vehicle width direction and abutting the instrument panel, a parting section (for example, a parting section (62) of the embodiment) being formed between the extension section and the instrument panel, and the parting section being formed at an angle that supports a ride feeling of an occupant.

According to the configuration of (1), the upper trim is separated from with the lower trim, and they are coupled via a coupling section. Accordingly, when the upper trim expands or contracts due to variation in atmospheric temperature, an expansion/contraction amount can be absorbed by the coupling section, and a force applied in a direction of the parting section (i.e., the parting line) is able to be minimized As a result, it is possible to prevent the height position of the upper surface of the lower trim from being misaligned when it is fitted to the instrument panel, and to reduce the likelihood of the design being impaired.

Since the extension section directed inward in the vehicle width direction is provided on the lower trim, when the upper trim expands or contracts due to variation in atmospheric temperature, a force applied in the direction of the parting section is further reduced. Accordingly, when combined with the instrument panel, occurrence of a distortion at the height position of the upper surface of the lower trim can be prevented, and the risk of impairing designability can be reduced.

Since the upper trim is separated from with the lower trim and the extension section directed inward in the vehicle width direction is provided on the lower trim, an influence of expansion and contraction due to a variation in atmospheric temperature of the upper trim can be less susceptible to the parting section. Accordingly, since the parting section can be stably placed, the parting section can function as a mark for the vanishing point of the driver.

Further, the parting section is disposed on a side further inward in the vehicle than the front pillar. Accordingly, it becomes easier for the driver to recognize the parting section by distinguishing it from the pillar, and the parting section more easily functions as a mark for the vanishing point of the driver.

(2) In the joining structure of the front pillar trim and the instrument panel according to the aspect of (1), the front pillar trim may include a rear upper trim (for example, a rear upper trim (33) of the embodiment) disposed on a side further rearward in a vehicle than the upper trim, the rear upper trim and the upper trim may be coupled via an upper coupling section (for example, a third coupling section (43) of the embodiment), and the upper coupling section may be disposed at a side further inward from the coupling section in a vehicle width direction.

According to the configuration of (2), the upper trim extends from the coupling section to the rear upper trim (i.e., the upper coupling section) in front of the vehicle and outward in the vehicle width direction. Accordingly, the field of view of the driver is widened, and the parting line can be easily compared with an object on a road.

(3) In the joining structure of the front pillar trim and the instrument panel according to the aspect of (1) or (2), the instrument panel may include stopper sections (for example, stopper sections (24) of the embodiment) protruding outward in a vehicle width direction and abutting an end portion (for example, an inner end portion (64) of the embodiment) of the extension section inside in the vehicle width direction to restrict downward movement of the end portion, at least one of the stopper section may be disposed on a side in front of the instrument panel, and the end portion of the extension section inside in the vehicle width direction may be disposed above the stopper section in a vertical direction and arranged to overlap the stopper section from above in the vertical direction.

According to the configuration of (3), since at least one of the stopper sections is provided at a side in front of the instrument panel, the parting line is disposed in front of the vehicle, and more easily functions as a mark for the vanishing point of the driver.

(4) In the joining structure between the front pillar trim and the instrument panel according to the aspect of (3), the stopper section may be arranged at only a side in front of the instrument panel.

According to the configuration of (4), the stopper section is provided at only a side in front of the instrument panel. Accordingly, in the portion that easily enters the field of view when the driver visually checks a forward side, when combined with the instrument panel, occurrence of a distortion at a height position of the upper surface due to the extension section can be prevented at low cost.

Since a range over which the stopper section abuts is limited, occurrence of noise due to this abutting can be minimized Further, for example, costs when felt for a muffling member configured to prevent noise is provided can be minimized.

(5) In the joining structure of the front pillar trim and the instrument panel according to the aspect of (3) or (4), the end portion of the extension section inside in the vehicle width direction may have a folded section (for example, a first folded section (65) of the embodiment), in the folded section, an upper surface (for example, an extension upper surface (45a) of the embodiment) of the extension section and a bent surface (for example, a first folded surface (65a) of the embodiment) may be folded to form an acute angle, and the parting section may be disposed on a side further inward in the vehicle width direction than the stopper section.

According to the configuration of (5), since the extension section forms an acute angle between the upper surface of the extension section and the bent surface in the bent section, the parting line can be placed on a side further inward in the direction of the vehicle. Accordingly, when the driver visually checks the vanishing point in front of the vehicle, the parting line can easily enter the field of view of the driver.

(6) In the joining structure of the front pillar trim and the instrument panel according to the aspect of (5), the end portion of the extension section in the vehicle width direction may include a muffling member (for example, a muffling member (75) of the embodiment) on a portion abutting the stopper section, and the angle (for example, an acute angle (θ) of the embodiment) formed between the upper surface of the extension section and the bent surface (for example, a second folded surface (66a) of the embodiment) in the portion comprising the muffling member may be smaller than an angle formed between the upper surface of the extension section and the bent surface in the portion that does not abut the stopper section in the end portion of the extension section inside in the vehicle width direction.

According to the configuration of (6), since the portion including the muffling member is folded at a more acute angle, the muffling member becomes less visible to the occupant, and the risk of impairing designability is reduced.

According to the joining structure of the front pillar trim and the instrument panel of the present invention, it is possible to prevent designability from being impaired and stabilize a height position of the parting line.

### BRIEF DESCRIPTION OF THE DRAWINGS

FIG. 1 is a perspective view showing a joining structure for a front pillar trim and an instrument panel of an embodiment according to the present invention from the side of a vehicle interior.

FIG. 2 is a perspective view showing the joining structure of the front pillar trim and the instrument panel of the embodiment.

FIG. 3 is a perspective view of the front pillar trim of the embodiment when seen from the side of the vehicle interior.

FIG. 4 is a perspective view of the front pillar trim of the embodiment from outside a vehicle.

FIG. 5 is a perspective view showing a first coupling section in FIG. 4 in a direction of an arrow V.

FIG. 6 is an enlarged perspective view of a portion VI in FIG. 4.

FIG. 7 is an enlarged perspective view of a portion VII in FIG. 4.

FIG. 8 is a plan view showing the joining structure of the front pillar trim and the instrument panel of the embodiment.

FIG. 9 is a plan view showing the instrument panel in FIG. 8.

FIG. 10 is a cross-sectional view taken along line X-X in FIG. 8.

FIG. 11 is a perspective view showing a state in which a muffling member is provided in a second folded section according to a variant of the embodiment.

FIG. 12 is a cross-sectional view corresponding to FIG. 10 according to the variant of the embodiment.

### DETAILED DESCRIPTION OF THE INVENTION

Hereinafter, an embodiment of the present invention will be described on the basis of the accompanying drawings. Further, in the drawings of the embodiment, an arrow FR indicates a forward direction in a vehicle, an arrow UP indicates an upward direction in the vehicle, and an arrow LH indicates a leftward direction in the vehicle.

A vehicle body structure 10 of the embodiment has a substantially laterally symmetrical configuration, and the same reference signs designate left and right components which will be described below.

### Vehicle Body Structure

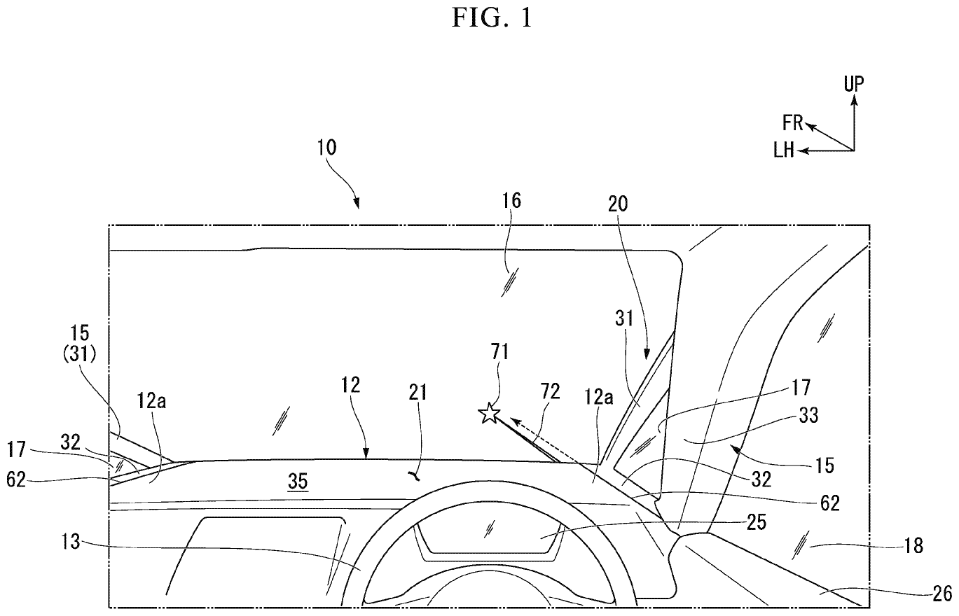

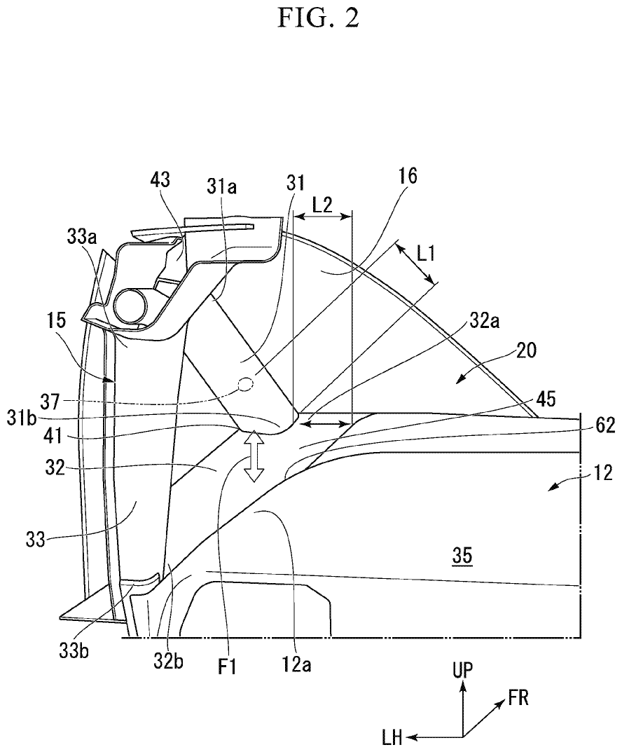

As shown in FIG. 1 and FIG. 2, the vehicle body structure 10, which is a structure in a vehicle interior that is brought into a field of view of a driver (an occupant), includes an instrument panel 12, a steering wheel 13, left and right front pillar trims 15, a front window glass 16, left and right front quarter window glasses 17, and left and right side window glasses 18.

Hereinafter, in the following description, the left and right front pillar trims 15 are simply referred to as “the front pillar trims 15,” the left and right front quarter window glasses 17 are simply referred to as “the front quarter window glasses 17” and the left and right side window glasses 18 are simply referred to as “the side window glasses 18”.

The instrument panel 12 is interposed between the left front pillar trim 15 and the right front pillar trim 15. An upper surface 21 of the instrument panel 12 (hereinafter, referred to as a panel upper surface) is disposed along a lower end portion of the front window glass 16. For example, meters 25 are disposed on the instrument panel 12 on the right side in the vehicle width direction. The steering wheel 13 is disposed above the meters 25 to the rear with respect to the vehicle body. The steering wheel 13 is disposed in front of a driver's seat (not shown) of the vehicle. The front pillar trims 15 are provided on left and right end portions 12a of the instrument panel 12.

Each of the front pillar trims 15 is formed of a frame body having a substantially triangular shape. The front window glass 16 is disposed in front of the front pillar trims 15 and the instrument panel 12 of the vehicle. The front quarter window glasses 17 are disposed outward from the front pillar trims 15 in the vehicle width direction. The side window glasses 18 are disposed on side doors 26.

A joining structure 20 of the front pillar trims 15 and the instrument panel 12 is configured by combining the front pillar trims 15 with the instrument panel 12. Hereinafter, the joining structure 20 of the front pillar trims 15 and the instrument panel 12 will be described.

### Joining Structure of Front Pillar Trim and Instrument Panel

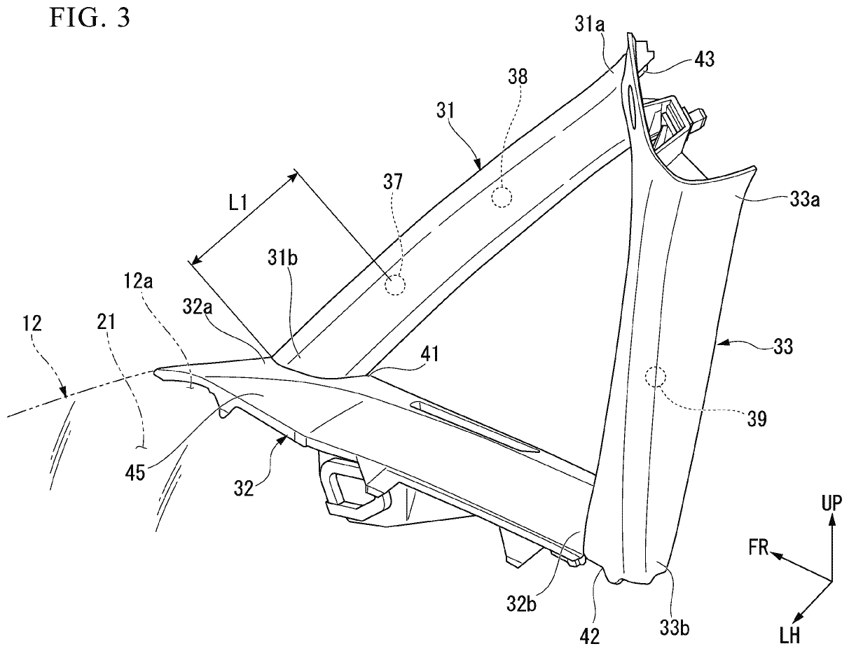

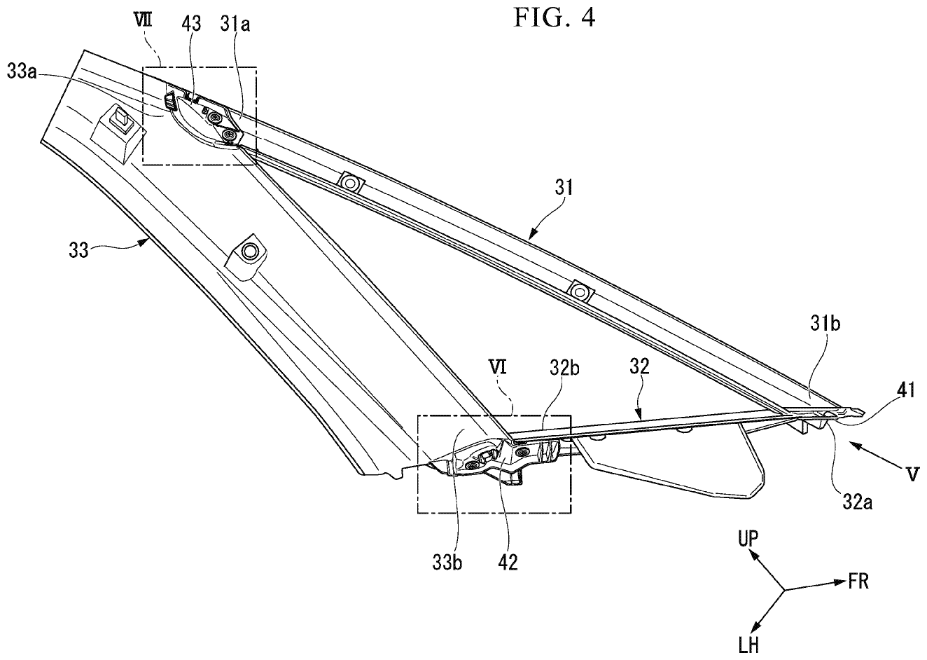

As shown in FIG. 3 and FIG. 4, the front pillar trim 15 includes a front upper trim (an upper trim) 31, a lower trim 32, and a rear upper trim 33. Each of the trims 31, 32, and 33 is formed of, for example, a resin material that expands and contracts to some extent at an atmospheric temperature (an environmental temperature).

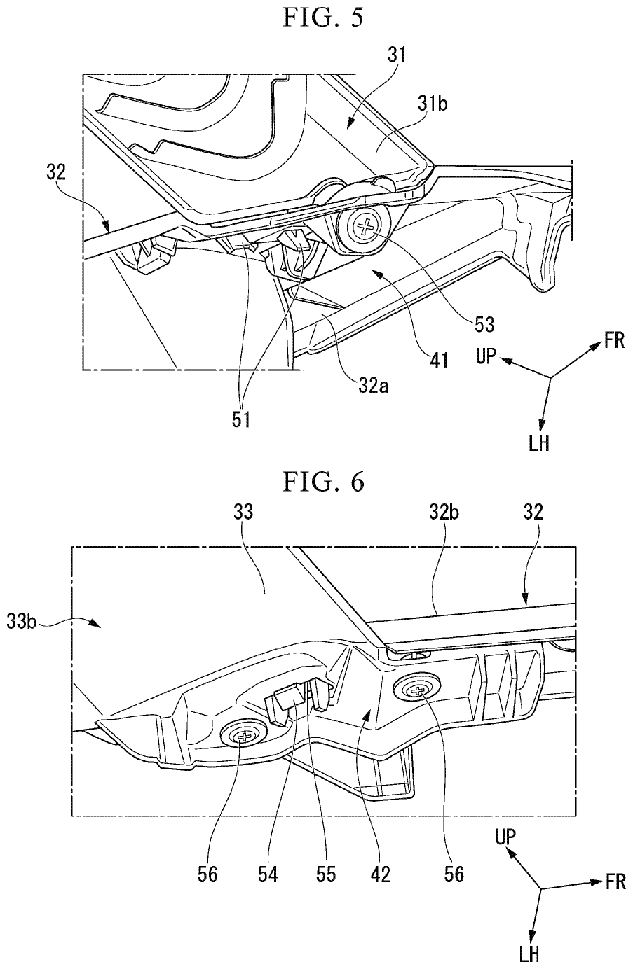

The front upper trim 31 is a decorative member configured to cover the front pillar (not shown) from the side of a vehicle interior 35 (see FIG. 1). The front upper trim 31 extends toward a side in front of the vehicle along a front side of the front quarter window glass 17 (see FIG. 1) from an upper end portion 31a to a lower end portion 31b at a downward gradient. The lower end portion 31b of the front upper trim 31 is coupled to a front end portion 32a of the lower trim 32 via a first coupling section (a coupling section) 41 (see FIG. 5).

Here, for example, when the front upper trim 31 and the lower trim 32 are formed integrally with each other, the lower end portion 31b of the front upper trim 31 may be formed to have roundness to expand in a curved shape. For this reason, it is difficult to secure a wide field of view of an occupant, and further, it is conceivable that a force generated upon expansion of the front upper trim 31 will tend to be applied to the inside in the vehicle width direction.

On the other hand, end portions of the front upper trim 31 inside in the vehicle width direction and in the upward/downward direction can be coupled by the first coupling section 41 to come into contact with the end portion of the lower trim 32 in the vehicle width direction by dividing the front upper trim 31 and the lower trim 32. Accordingly, the lower end portions 31b of the front upper trims 31 can be coupled so as not to be rounded. Accordingly, the field of view of the occupant can be widened, and the force generated during expansion of the front upper trim 31 is unlikely to be applied to the inside in the vehicle width direction.

For example, the front upper trim 31 is fixed to the front pillar by a first clip 37 and a second clip 38 disposed at equal intervals in a lengthwise direction. Accordingly, an expansion/contraction amount of the front upper trim 31 in the lengthwise direction provided on the front end portion 32a of the lower trim 32 can be minimized to an expansion/contraction amount of a distance L1 between the first clip 37 and the lower end portion 31b of the front upper trim 31. Accordingly, an influence provided on the front end portion 32a of the lower trim 32 by the expansion/contraction amount of the front upper trim 31 in the lengthwise direction can be minimized.

The influence provided on the front end portion 32a of the lower trim 32 by the expansion/contraction amount of the front upper trim 31 in the lengthwise direction will be described below in detail.

The lower trims 32 are coupled to the left and right end portions 12a (the left end portion 12a, see FIG. 2) of the instrument panel 12. The lower trims 32 overhang outward from the left and right end portions 12a of the instrument panel 12 in the vehicle width direction to be substantially flush with the panel upper surface 21 of the instrument panel 12. The lower trims 32 have extension sections 45. The extension sections 45 are disposed along lower sides of the front quarter window glasses 17 (see FIG. 1). A rear end portion 32b of the lower trim 32 is coupled to a lower end portion 33b of the rear upper trim 33 via a second coupling section 42.

The rear upper trim 33 is a decorative member disposed on a side further rearward in the vehicle than the front upper trim 31 and the lower trim 32 and configured to cover a front quarter window frame (not shown) from the side of the vehicle interior 35. The rear upper trim 33 extends downward along rear sides of the front quarter window glasses 17 (see FIG. 1) from an upper end portion 33a to the lower end portion 33b. The upper end portion 33a of the rear upper trim 33 is coupled to the upper end portion 31a of the front upper trim 31 via a third coupling section (an upper coupling section) 43.

For example, rear upper trim 33 is fixed to the front quarter window frame by a third clip 39 disposed at a center in the lengthwise direction.

As shown in FIG. 5, in the first coupling section 41, a first locking claw 51 of the front upper trim 31 is locked to a first locking hole of the lower trim 32. In the first coupling section 41, the lower end portion 31b of the front upper trim 31 and the front end portion 32a of the lower trim 32 are coupled by a first bolt 53.

As shown in FIG. 6, in the second coupling section 42, a second locking claw 54 of the lower trim 32 is locked to a second locking hole 55 of the rear upper trim 33. In the second coupling section 42, the lower end portion 33b of the rear upper trim 33 and the rear end portion 32b of the lower trim 32 are coupled by a second bolt 56.

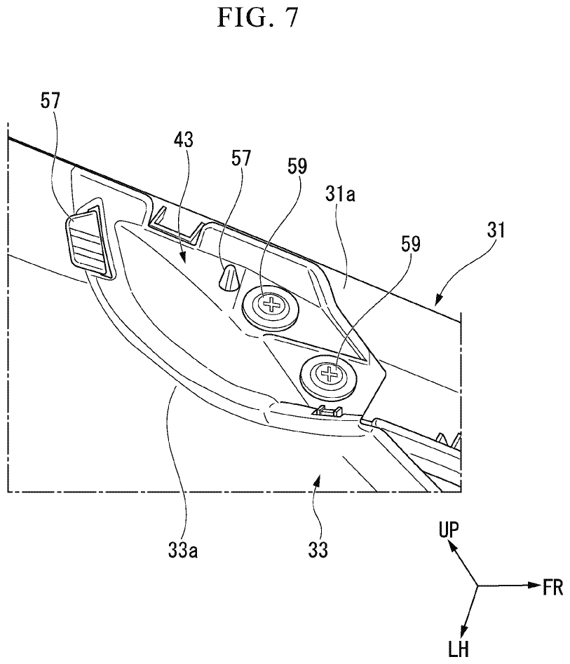

As shown in FIG. 7, in the third coupling section 43, a third locking claw 57 of the front upper trim 31 is locked to a third locking hole of the rear upper trim 33. In the third coupling section 43, the upper end portion 31a of the front upper trim 31 and the upper end portion 33a of the rear upper trim 33 are coupled by a third bolt 59.

In this way, the front pillar trims 15 are divided into three trims of the front upper trim 31, the lower trim 32 and the rear upper trim 33, and the trims 31, 32, and 33 are coupled by the first coupling section 41, the second coupling section 42, and the third coupling section 43 in a triangular shape.

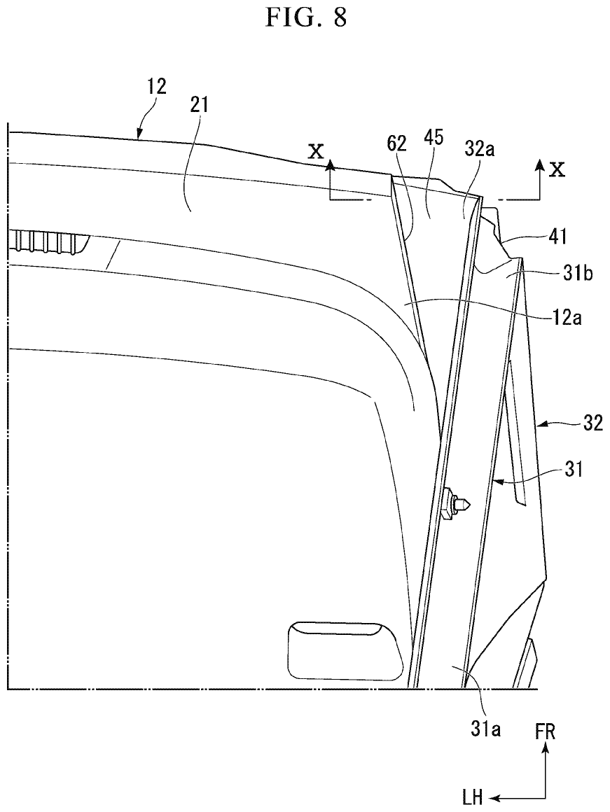

As shown in FIG. 3 and FIG. 8, the front upper trim 31 is separated from with the lower trim 32 and coupled by the first coupling section 41 (see FIG. 5). The first coupling section 41 is disposed on a further outward side in the vehicle width direction than the third coupling section 43 (see FIG. 7). In other words, the third coupling section 43 is disposed on a side further inward in the vehicle width direction than the first coupling section 41.

The extension section 45 extends inward from the first coupling section 41 in the vehicle width direction and abuts the instrument panel 12. A parting section (i.e., a parting line) 62 is formed between the extension section 45 and the instrument panel 12.

The instrument panel 12, the extension section 45, and the parting section 62 will be described below in detail.

As shown in FIG. 8 to FIG. 10, the instrument panel 12 includes the panel upper surface 21, a panel inclined surface 22, a panel locking hole 23, and a stopper section 24.

The panel upper surface 21 is a flat surface formed substantially horizontally along a lower end of the front window glass 16 (see FIG. 1) of the instrument panel 12. The panel inclined surface 22 is inclined from left and right end portions 21a (only the left end portion 21a is shown) of the panel upper surface 21 toward an outside in the vehicle width direction at a downward gradient.

The panel locking holes 23 pass in the upward/downward direction on left and right sides (only the right side is shown) of the panel inclined surface 22. A locking claw and a clip (not shown) of the extension section 45 are locked to the panel locking hole 23 such that they can slide in the upward/downward direction to some extent. That is, the extension section 45 is locked to the instrument panel 12 via the locking claw and the clip such that it can slide in the upward/downward direction to some extent.

The stopper sections 24 protrude outward from lower end portions 22a of the panel inclined surfaces 22 (only the right side is shown) in the vehicle width direction. A shape of the stopper section 24 is not limited to a linear shape. As another example, ribs protruding upward from outer ends of the stopper sections 24 in the vehicle width direction may be provided. The stopper section 24 may protrude from the lower end portion 22a of the panel inclined surface 22 to form a triangular shape such that a cross section in the upward/downward direction gradually reduces in size.

The stopper section 24 abuts an inner end portion (end portion) 64 of the extension section 45 inside in the vehicle width direction and restricts downward movement of the inner end portion 64. For example, at least one of the stopper sections 24 is disposed on a side in front of the vehicle in the left and right end portions of the instrument panel 12 (specifically, the panel inclined surface 22). In the embodiment, for example, the stopper sections 24 are arranged on the panel inclined surface 22 at only a side in front of the vehicle.

The inner end portion 64 of the extension section 45 is disposed above the stopper section 24 in the vertical direction and arranged to overlap the stopper section 24 from above in the vertical direction.

The inner end portion 64 of the extension section 45 has a first folded section (a folded section) 65. Further, in consideration of the following variant, the folded section will be described as the first folded section 65.

The first folded section 65 is folded such that a first folded surface (a bent surface) 65a is formed at an acute angle with respect to an upper surface 45a (hereinafter, referred to as an extension upper surface 45a) of the extension section 45. Specifically, the first folded section 65 is folded such that the first folded surface 65a has a downward gradient of an acute angle with respect to the extension upper surface 45a from an inner end 45b of the extension upper surface 45a toward an outside in the vehicle width direction.

In the inner end portion 64 of the extension section 45, the first folded surface 65a of the first folded section 65 is disposed along the panel inclined surface 22. A lower end portion 65b of the first folded section 65 abuts (is placed on) the stopper section 24 from above. In this state, the extension upper surface 45a is disposed slightly below the panel upper surface 21 by a dimension H1. An inner edge 64a of the inner end portion 64 of the extension section 45 is combined with the panel inclined surface 22 while abutting (coming into contact with) the panel inclined surface 22. The parting section 62 is formed between the inner edge 64a of the inner end portion 64 of the extension section 45 and the panel inclined surface 22. The parting section 62 is disposed on a side further inward in the vehicle width direction than the stopper section 24 and at a position within a field of view of the driver who is sitting on the driver's seat. The parting section 62 is formed at an angle that supports a ride feeling of the driver.

As shown in FIG. 1, the parting section 62 is disposed at an angle that substantially coincides with an axis 72 toward the inside of the vehicle interior 35 among axes radially extending from a vanishing point 71 on a side in front of the vehicle when the driver who is sitting on the driver's seat visually checks the side in front of the vehicle. Accordingly, the parting section 62 can be matched to the information of the vehicle exterior environment perceived by the driver, and the parting section 62 can function as a mark for the vanishing point 71 of the driver. That is, the parting section 62 can support a ride feeling of the driver.

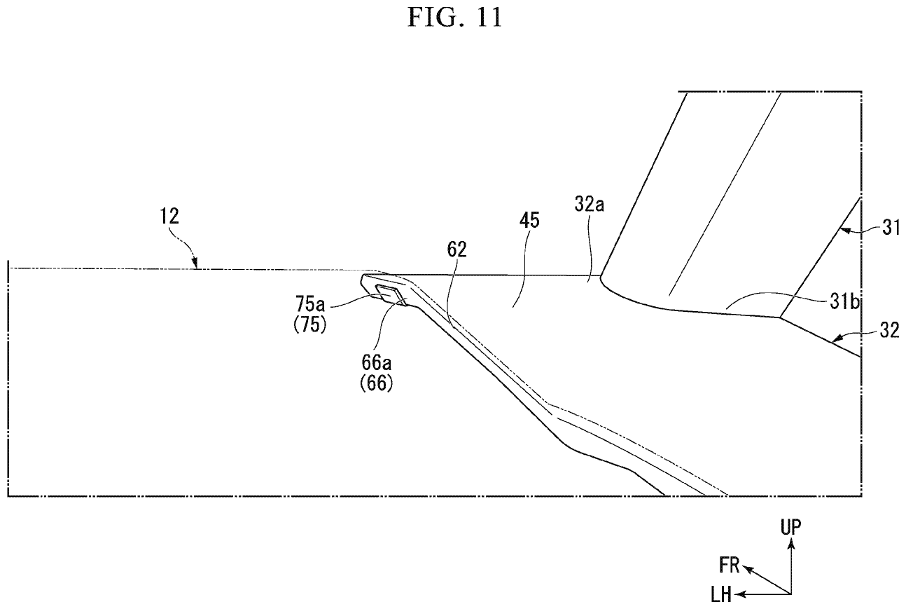

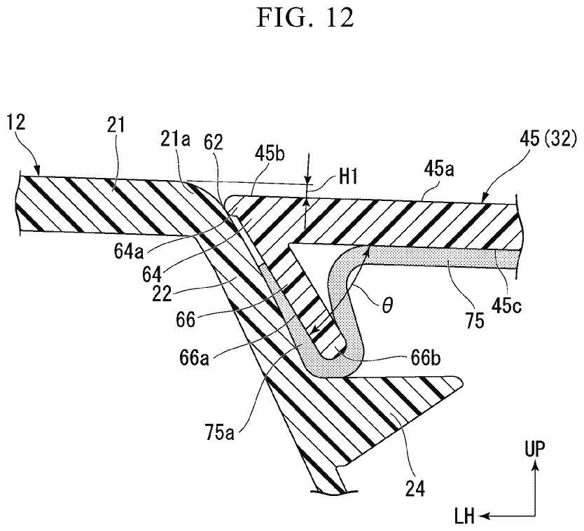

According to the above-mentioned joining structure 20 of the front pillar trim 15 and the instrument panel 12, as shown in FIG. 2 and FIG. 11, the front upper trim 31 is separated from with the lower trim 32. The lower end portion 31b of the front upper trim 31 is coupled to the front end portion 32a of the lower trim 32 at the first coupling section 41. Further, the front upper trim 31 is fixed to the front pillar (not shown) by the first clip 37.

Accordingly, the front upper trim 31 can absorb the expansion/contraction amount in the distance L1 between the first clip 37 and the lower end portion 31b to some extent in the first coupling section 41 when the front upper trim 31 expands or contracts in the lengthwise direction due to a variation in atmospheric temperature. That is, a force applied in a direction of the parting section 62 (in particular, a force applied in the upward/downward direction) F1 can be minimized by the expansion/contraction amount of the front upper trim 31.

The lower end portion 65b of the first folded section 65 abuts (is placed on) the stopper section 24 from above. Accordingly, when the force F1 is applied downward by the expansion amount of the front upper trim 31, downward movement of the extension upper surface 45a can be prevented by the stopper section 24.

Further, the extension upper surface 45a is disposed below the panel upper surface 21 of the instrument panel 12 by the Dimension H1. Accordingly, when the force F1 is applied upward by the contraction amount of the front upper trim 31, upward movement of the extension upper surface 45a beyond the panel upper surface 21 can be prevented.

In this way, it is possible to minimize the force F1 applied to the parting section 62, prevent downward movement of the extension upper surface 45a using the stopper section 24, and further, prevent upward movement of the extension upper surface 45a beyond the panel upper surface 21. Accordingly, when combined with the instrument panel 12, it is possible to prevent occurrence of distortion at a height position of the extension upper surface 45a of the lower trim 32 and reduce the risk of impairing designability.

The extension section 45 directed inward in the vehicle width direction is provided on the lower trim 32. That is, the lower end portion 31b of the front upper trim 31 is disposed to be separated outward from the parting section 62 in the vehicle width direction by L2. Accordingly, when the front upper trim 31 expands or contracts due to a variation in atmospheric temperature, the force applied in the direction of the parting section 62 (in particular, the force applied in the upward/downward direction) F1 can be minimized.

Accordingly, when combined with the instrument panel 12, it is possible to further prevent occurrence of deviation at a height position of the extension upper surface 45a of the lower trim 32 and reduce the risk of impairing the design.

Further, the front upper trim 31 is separated from with the lower trim 32, and the extension section 45 is provided on the lower trim 32. Accordingly, the influence of expansion and contraction due to a variation in atmospheric temperature of the front upper trim 31 can be made less susceptible to the parting section 62. Accordingly, the parting section 62 can be stably set, and function as a mark with respect of the vanishing point 71 of the driver.

In addition, the parting section 62 is disposed on a side further inward in the vehicle direction than the front upper trim 31 (i.e., the front pillar). Accordingly, it becomes easier for the driver to recognize the parting section 62 by distinguishing it from the front upper trim 31 and the parting section can more easily function as the mark for the vanishing point 71 of the driver.

The front upper trim 31 extends from the third coupling section 43 with the rear upper trim 33 toward the side in front of the vehicle and outward in the vehicle width direction. Accordingly, the field of view of the driver becomes wider, which makes it easier to compare the parting section 62 with an object on the road. Further, a wide space for the vehicle interior 35 can be secured by disposing the front upper trim 31 on an outward side in the vehicle width direction.

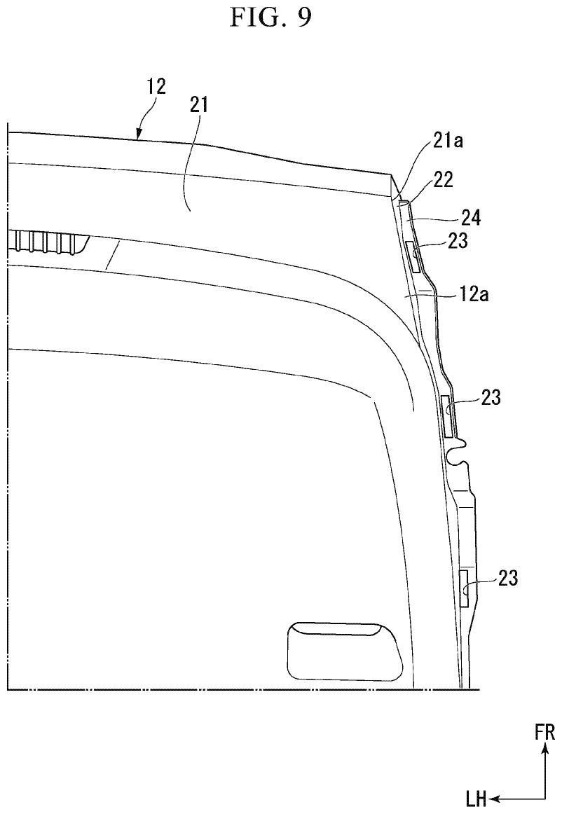

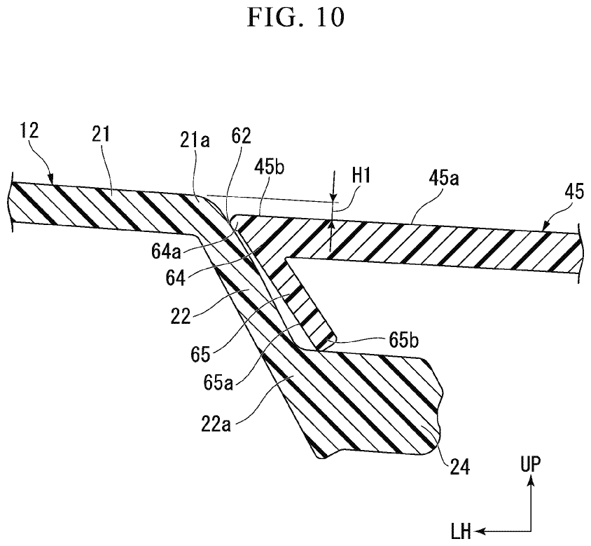

Further, as shown in FIG. 2, FIG. 9 and FIG. 12, at least one of the stopper sections 24 is provided on the instrument panel 12 at the forward side of the vehicle. Accordingly, the parting section 62 can be disposed in front of the vehicle to make it easier to function as the mark for the vanishing point 71 of the driver.

In addition, in the embodiment, the stopper section 24 is provided only in front of the instrument panel 12. Accordingly, in a portion that easily enters the field of view when the driver visually checks a side in front of the vehicle, when combined with the instrument panel 12, it is possible to prevent occurrence of distortion at the height position due to the extension upper surface 45a at a low cost.

Since a range in which the extension section 45 abuts the stopper section 24 can be limited to being smaller, occurrence of a noise (unwanted sound) due to abutting of the stopper section 24 and the extension section 45 can be minimized. Further, as a muffling member configured to prevent noise, for example, when felt is provided, the shape of the muffling member can be minimized, and costs of the muffling member can be minimized.

As shown in FIG. 10 and FIG. 12, the inner end portion 64 of the extension section 45 is folded in the first folded section 65 such that the first folded surface 65a forms an acute angle with respect to the extension upper surface 45a. Accordingly, the inner edge 64a of the inner end portion 64 of the extension section 45 (i.e., the parting section 62) can be disposed (set) at a position on a further inward side in the vehicle direction.

Accordingly, when the driver visually checks the vanishing point 71 in front of the vehicle, the parting section 62 can easily enter the field of view of the driver.

### Variant

Next, a variant of the embodiment will be described with reference to FIG. 11 and FIG. 12. The variant is configured by providing a muffling member 75 on a folded section, and the configuration is otherwise the same as that of the embodiment. In the variant, in consideration of the embodiment, the folded section will be described as a second folded section 66.

As shown in FIG. 11 and FIG. 12, the inner end portion 64 of the extension section 45 includes the muffling member 75 on the second folded section 66. The second folded section θ with respect to the extension upper surface 45a. The acute angle θ of the second folded surface 66a is smaller than an angle formed between the extension upper surface 45a of the extension section 45 and the bent surface in the portion that does not abut the stopper section 24 in the inner end portion 64 of the extension section 45 inside in the vehicle width direction.

For example, a felt is provided on the second folded section 66 as the muffling member 75. That is, an angle θ formed between the extension upper surface 45a and the second folded surface 66a in the portion including the muffling member 75 is smaller than an angle formed between the extension upper surface 45a of the extension section 45 and the bent surface in the portion that does not abut the stopper section 24 in the inner end portion 64 of the extension section 45.

In the muffling member 75, an inner end portion 75a is disposed along the second folded surface 66a and disposed along a lower surface 45c of the extension section 45 via a lower end portion 66b of the second folded section 66. In the muffling member 75, the inner end portion 75a abuts the panel inclined surface 22 and the stopper section 24.

Accordingly, when the force is applied downward by the expansion amount of the front upper trim 31, downward movement of the extension upper surface 45a can be minimized by the stopper section 24.

Further, the extension upper surface 45a is disposed below the panel upper surface 21 of the instrument panel 12 by the Dimension H1. Accordingly, when a force is applied upward by the contraction amount of the front upper trim 31, upward movement of the extension upper surface 45a beyond the panel upper surface 21 can be minimized.

In the second folded section 66, the acute angle θ of the second folded surface 66a is smaller than the angle formed between the extension upper surface 45a of the extension section 45 and the bent surface in the portion that does not abut the stopper section 24 in the inner end portion 64 of the extension section 45 inside in the vehicle width direction. Accordingly, an inner end portion 75a of the muffling member (for example, the felt) 75 cannot be easily visually recognized by the occupant, and the risk of impairing designability can be reduced.

While preferred embodiments of the invention have been described and shown above, it should be understood that these are exemplary of the invention and are not to be conceivable as limiting. Additions, omissions, substitutions, and other modifications can be made without departing from the spirit or scope of the present invention. Accordingly, the invention is not to be conceivable as being limited by the foregoing description, and is only limited by the scope of the appended claims.

### EXPLANATION OF REFERENCES

10 Vehicle body structure

12 Instrument panel

15 Front pillar trim

20 Joining structure of front pillar trim and instrument panel

24 Stopper section

31 Front upper trim (upper trim)

32 Lower trim

33 Rear upper trim

41 First coupling section (coupling section)

43 Third coupling section (upper coupling section)

45 Extension section

45a Extension supper surface (upper surface of extension section)

62 Parting section (parting line)

64 Inner end portion of extension section (end portion of extension section inside in vehicle width direction)

65 First folded section (folded section)

65a First folded surface (bent surface)

66 Second folded section (folded section)

66a Second folded surface (bent surface)

75 Muffling member

θ Acute angle

What is claimed is:

1. A joining structure between a front pillar trim and an instrument panel,
wherein the front pillar trim comprises an upper trim and a lower trim,
the lower trim and the upper trim are coupled via a coupling section,
the lower trim has an extension section extending from the coupling section toward an inward side in a vehicle width direction and abutting the instrument panel,
a parting section is formed between the extension section and the instrument panel, and
the parting section is formed at an angle that supports a ride feeling of an occupant.

2. The joining structure of the front pillar trim and the instrument panel according to claim 1, wherein the front pillar trim comprises a rear upper trim disposed on a side further rearward in a vehicle than the upper trim,
the rear upper trim and the upper trim are coupled via an upper coupling section, and
the upper coupling section is disposed at a side further inward from the coupling section in a vehicle width direction.

3. The joining structure of the front pillar trim and the instrument panel according to claim 1, wherein
the instrument panel comprises stopper sections protruding outward in a vehicle width direction and abutting an end portion of the extension section inside in the vehicle width direction to restrict downward movement of the end portion,
at least one of the stopper section is disposed on a side in front of the instrument panel, and
the end portion of the extension section inside in the vehicle width direction is disposed above the stopper section in a vertical direction and arranged to overlap the stopper section from above in the vertical direction.

4. The joining structure of the front pillar trim and the instrument panel according to claim 3, wherein the stopper section is arranged only at a side in front of the instrument panel.

5. The joining structure of the front pillar trim and the instrument panel according to claim 3, wherein the end portion of the extension section inside in the vehicle width direction has a folded section,
in the folded section, an upper surface of the extension section and a bent surface are folded to form an acute angle, and
the parting section is disposed on a side further inward in the vehicle width direction than the stopper section.

6. The joining structure of the front pillar trim and the instrument panel according to claim 5, wherein
the end portion of the extension section inside in the vehicle width direction comprises a muffling member on a portion abutting the stopper section, and
the angle formed between the upper surface of the extension section and the bent surface in the portion comprising the muffling member is smaller than an angle formed between the upper surface of the extension section and the bent surface in the portion that does not abut the stopper section in the end portion of the extension section inside in the vehicle width direction.
